(19) United States
(12) Patent Application Publication
(10) Pub. No.: US 2020/0183094 A1
(43) Pub. Date: Jun. 11, 2020

(54) FIBER OPTIC FERRULE INSPECTION TOOL WITH CONTAMINATION DETECTION AND CLEANING DEVICE

(71) Applicant: COMMSCOPE TECHNOLOGIES LLC, Hickory, NC (US)

(72) Inventors: Giorgio POLICANTE, Steensel (NL); Laurens Izaak WUIJCKHUIJSE, Rosmalen (NL); Antonius Bernardus Gerardus BOLHAAR, Ophemert (NL); Franciscus Karel Maria VAN GEIJN, Baarle-Nassau (NL); Dirk Alexander DE GAST, Geldermalsen (NL); Paul SCHNEIDER, Gemonde (NL); Tom DE BOER, Utrecht (NL)

(73) Assignee: COMMSCOPE TECHNOLOGIES LLC, Hickory, NC (US)

(21) Appl. No.: 16/316,286

(22) PCT Filed: Jul. 7, 2017
(86) PCT No.: PCT/US2017/041107

§ 371 Date: Jan. 8, 2019

Related U.S. Application Data
(60) Provisional application No. 62/360,131, filed on Jul. 8, 2016.

(51) Int. Cl. G02B 6/38; B08B 5/02; B08B 9/00

(52) U.S. Cl. CPC G02B 6/3866; B08B 9/00; B08B 5/02; G02B 6/385

(57) ABSTRACT

A fiber optic ferrule inspection tool (100) inspects and cleans a fiber optic ferrule (900). The tool includes a mounting arrangement (216), a camera (500), a grazing light assembly (800), an axial light (512), and a nozzle (320, 320′). The mounting arrangement (216) is adapted to releasably mount the fiber optic ferrule. The camera (500) is mounted to the mounting arrangement and captures at least one image (920, 922) of the fiber optic ferrule. The grazing light assembly (800) is mounted to the mounting arrangement and is adapted to emit grazing light and thereby illuminate an end (902) of the fiber optic ferrule. Rays (rg) of the grazing light are oriented to the end of the fiber optic ferrule within an angular range of 0 to 30 degrees. Rays (ra) of the axial light (512) are oriented to the end of the fiber optic ferrule about an angular range within 30 to 90 degrees. The nozzle (320, 320′) is positioned by the mounting arrangement and is adapted to supply ionized air (352) and thereby clean and electrostatically neutralize the fiber optic ferrule.

### CROSS-REFERENCE TO RELATED APPLICATION

This application is being filed on Jul. 7, 2017 as a PCT International Patent Application and claims the benefit of U.S. Patent Application Ser. No. 62/360,131, filed on Jul. 8, 2016, the disclosure of which is incorporated herein by reference in its entirety.

### TECHNICAL FIELD

The present disclosure relates to inspection and cleaning of fiber optic ferrules and/or fiber optic connectors. In particular, the present disclosure relates to optical inspection of an end face of the fiber optic ferrule using various lighting, and cleaning the end face of the fiber optic ferrule with ionized air and thereby electrostatically neutralizing the fiber optic ferrule.

### BACKGROUND

In the field of fiber optic telecommunications, there is a need to optically connect various optical fibers together to complete optical circuits. The optical fibers are often optically connected together using fiber optic ferrules. The fiber optic ferrules may be included in a fiber optic connector. The fiber optic ferrules may each terminate a single optical fiber or may terminate a plurality of optical fibers. Examples of multi-fiber fiber optic ferrules include MT ferrules, PC and APC connectors and ferrules, MPO and MTP connectors, etc. The fiber optic ferrules may include a plastic body. The plastic body may be formed using injection molding techniques.

Optical connections formed between fiber optic ferrules terminating one or more optical fiber may be degraded if contamination and/or physical damage is present. For example, if the end face of the fiber optic ferrule is scratched, pitted, deformed, upset, or otherwise damaged, the optical connection between the fiber optic ferrule and a mating fiber optic ferrule may be compromised. As another example, if dust, dirt, lint, or other contaminants are present between a pair of mated fiber optic ferrules, the optical connection between the mated fiber optic ferrules may be compromised.

To reduce the likelihood of a given fiber optic ferrule being compromised, inspection of the fiber optic ferrule may be performed. The inspection of the fiber optic ferrule may include looking at the end face for physical defects to the end face and/or looking at the fiber optic ferrule for contamination. The fiber optic ferrules may be cleaned to reduce the likelihood of contamination on the end face of the fiber optic ferrule and thereby reduce the likelihood of reduced performance of the optical fiber connection because of contamination between the pair of end faces. However, as the fiber optic ferrules may include a plastic material, wiping the fiber optic ferrule with a cloth to remove contamination may electrostatically charge the fiber optic ferrule and thereby electrostatically attract contaminants to the fiber optic ferrule.

### SUMMARY

The present disclosure relates to a fiber optic ferrule inspection tool for inspecting a fiber optic ferrule. The fiber optic ferrule inspection tool includes a mounting arrangement, a camera, and a nozzle. The mounting arrangement is adapted to releasably mount the fiber optic ferrule. The camera is mounted to the mounting arrangement. The camera is adapted to capture at least one image of the fiber optic ferrule, when the fiber optic ferrule is mounted to the mounting arrangement. The nozzle is positioned by the mounting arrangement. The nozzle is adapted to supply a cleaning fluid to the fiber optic ferrule and thereby clean the fiber optic ferrule with the cleaning fluid.

In certain embodiments, the mounting arrangement is adapted to releasably mount a fiber optic connector and thereby is adapted to releasably mount the fiber optic ferrule. At least a portion of the nozzle may be mounted to the mounting arrangement. In other embodiments, at least a portion of the nozzle may be integrated with a mounting member of the mounting arrangement. The fiber optic ferrule inspection tool may further include an ionizer that is mounted to the mounting arrangement. The ionizer may be adapted to ionize air. The cleaning fluid that the nozzle is adapted to supply may be ionized air that is ionized by the ionizer.

In certain embodiments, the fiber optic ferrule inspection tool may further include a valve with a first position and a second position. When the valve is at the first position, the valve may be adapted to deliver a purging flow of the cleaning fluid to the fiber optic ferrule inspection tool that is sufficient to prevent contaminants from collecting within the tool. When the valve is at the second position, the valve may be adapted to deliver an increased burst flow (e.g., a blast of flow) of the cleaning fluid that is sufficient to remove contaminants from the fiber optic ferrule when the fiber optic ferrule is mounted to the mounting arrangement.

In certain embodiments, the fiber optic ferrule inspection tool may further include a grazing light assembly that is mounted to the mounting arrangement. The grazing light assembly may be adapted to emit grazing light and thereby illuminate an end of the fiber optic ferrule when the fiber optic ferrule is mounted to the mounting arrangement. The grazing light assembly may be oriented such that rays of the grazing light assembly are oriented to the end of the fiber optic ferrule within an angular range of 0° to 30°. The grazing light assembly may include at least one first light emitter that is adapted to emit a first frequency of electromagnetic radiation and may further include at least one second light emitter that is adapted to emit a second frequency of electromagnetic radiation. The grazing light assembly may be configured in a substantially annular configuration that encircles the end of the fiber optic ferrule when the fiber optic ferrule is mounted to the mounting arrangement. The grazing light assembly may include at least one fluid passage that is adapted to carry the cleaning fluid.

The fiber optic ferrule inspection tool may further include an axial light and diffused light. In certain embodiments, the axial light may be oriented such that rays of the axial light are oriented to the end of the fiber optic ferrule about an angular range of 75° to 90° when the fiber optic ferrule is mounted to the mounting arrangement. In certain embodiments, the axial light may be oriented such that rays of the axial light are oriented to the end of the fiber optic ferrule about an angular range of 30° to 90° when the fiber optic ferrule is mounted to the mounting arrangement. In certain embodiments, the axial light is configured in a substantially annular configuration that is positioned around a light receiver of the camera. In certain embodiments, the fiber optic ferrule inspection tool further includes a first polarizing filter positioned over the light receiver of the camera and a second polarizing filter that is positioned over the axial light. The first and the second polarizing filters may be angularly adjustable with respect to each other.

The fiber optic ferrule inspection tool may further comprise an aperture that is positioned between the camera and the fiber optic ferrule when the fiber optic ferrule is mounted to the mounting arrangement.

The fiber optic ferrule inspection tool may further include a plurality of adapters that are each adapted to hold one of a plurality of fiber optic ferrule styles and/or a plurality of fiber optic connector styles. The fiber optic ferrule inspection tool may thereby be adapted to releasably mount the fiber optic ferrule via an appropriate one of the plurality of adapters.

Other aspects of the present disclosure relate to a method of inspecting a fiber optic ferrule. The method includes providing a fiber optic ferrule inspection tool, mounting the fiber optic ferrule in a port of the fiber optic ferrule inspection tool, ionizing air with an ionizer and thereby producing ionized air, directing a flow of the ionized air at the fiber optic ferrule within the fiber optic ferrule inspection tool thereby electrostatically neutralizing the fiber optic ferrule, and optically inspecting the fiber optic ferrule with the fiber optic ferrule inspection tool. In certain embodiments, the method may further include wiping the fiber optic ferrule with a cloth prior to mounting the fiber optic ferrule in the port of the fiber optic ferrule inspection tool and removing any lint of the cloth that is attached to the fiber optic ferrule with the flow of the ionized air at the fiber optic ferrule. The method may further include illuminating the fiber optic ferrule with an axial light while optically inspecting the fiber optic ferrule. In certain embodiments, the axial light may be oriented such that rays of the axial light are oriented to an end of the fiber optic ferrule about an angular range of 75° to 90°. In certain embodiments, the axial light may be oriented such that rays of the axial light are oriented to an end of the fiber optic ferrule about an angular range of 30° to 90°. The method may further include illuminating the fiber optic ferrule with a grazing light while optically inspecting the fiber optic ferrule. The grazing light may be oriented such that rays of the grazing light are oriented to the end of the fiber optic ferrule about an angular range within 0° to 30°.

Still other aspects of the present disclosure relate to a fiber optic ferrule inspection tool for inspecting a fiber optic ferrule. The fiber optic ferrule inspection tool includes a mounting arrangement, a camera, a grazing light assembly, and an axial light. The mounting arrangement is adapted to releasably mount the fiber optic ferrule. The camera is mounted to the mounting arrangement. The camera is adapted to capture at least one image of the fiber optic ferrule when the fiber optic ferrule is mounted to the mounting arrangement. The grazing light assembly is mounted to the mounting arrangement. The grazing light assembly is adapted to emit grazing light and thereby illuminate an end of the fiber optic ferrule when the fiber optic ferrule is mounted to the mounting arrangement. The grazing light assembly is oriented such that rays of the grazing light are oriented to the end of the fiber optic ferrule within an angular range of 0° to 30°. In certain embodiments, the axial light is oriented such that rays of the axial light are oriented to the end of the fiber optic ferrule about an angular range within 30° to 90° when the fiber optic ferrule is mounted to the mounting arrangement. In certain embodiments, the axial light is oriented such that rays of the axial light are oriented to the end of the fiber optic ferrule about an angular range within 75° to 90° when the fiber optic ferrule is mounted to the mounting arrangement. In certain embodiments, the fiber optic ferrule inspection tool may further include a nozzle positioned by the mounting arrangement. The nozzle may be adapted to supply ionized air to the fiber optic ferrule and thereby clean the fiber optic ferrule.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a partially schematic perspective view of an example fiber optic ferrule inspection tool, according to the principles of the present disclosure;

FIG. 2 is an enlarged portion of FIG. 1, as called out at FIG. 1;

FIG. 3 is an exploded perspective view of the fiber optic ferrule inspection tool of FIG. 1, but without the schematic components;

FIG. 4 is an enlarged portion of FIG. 3, as called out at FIG. 3;

FIG. 5 is another perspective view of the example fiber optic ferrule inspection tool of FIG. 1, but without the schematic components;

FIG. 6 is the perspective view of FIG. 5, but exploded;

FIG. 7 is an enlarged portion of FIG. 6, as called out at FIG. 6;

FIG. 8 is a partial end view of the fiber optic ferrule inspection tool of FIG. 1;

FIG. 9 is still another perspective view of the fiber optic ferrule inspection tool of FIG. 1, but without the schematic components;

FIG. 10 is a reverse end view of the fiber optic ferrule inspection tool of FIG. 1, but without the schematic components;

FIG. 11 is a perspective cross-sectional view of the fiber optic ferrule inspection tool of FIG. 10, as called out at FIG. 10;

FIG. 12 is an enlarged portion of FIG. 11, as called out at FIG. 11;

FIG. 13 is the reverse end view of FIG. 10;

FIG. 14 is a perspective cross-sectional view of the fiber optic ferrule inspection tool of FIG. 13, as called out at FIG. 13;

FIG. 15 is an enlarged portion of FIG. 14, as called out at FIG. 14;

FIG. 16 is a perspective cross-sectional view of the fiber optic ferrule inspection tool of FIG. 13, as called out at FIG. 13;

FIG. 17 is an enlarged portion of FIG. 16, as called out at FIG. 16;

FIG. 18 is a perspective view of the fiber optic ferrule inspection tool of FIG. 1, but without the schematic components and without housing covers;

FIG. 19 is a partial perspective view of the fiber optic ferrule inspection tool of FIG. 1 cut-away to reveal a port and a nozzle of the fiber optic ferrule inspection tool;

FIG. 20 is a side elevation view of a base of the fiber optic ferrule inspection tool of FIG. 1;

FIG. 21 is a partial cross-sectional perspective view of the base of FIG. 20, as called out at FIG. 20;

FIG. 22 is a partial cross-sectional perspective view of the base of FIG. 20, as called out at FIG. 20;

FIG. 23 is a partial perspective view of another fiber optic ferrule inspection tool with a removable nozzle, according to the principles of the present disclosure;

FIG. 24 is a partial top plan cross-sectional view of the fiber optic ferrule inspection tool of FIG. 23;

FIG. 25 is a schematic view illustrating an ionized air supply system compatible with the fiber optic ferrule inspection tools of FIGS. 1 and 23; and

FIG. 26 is a semi-schematic view of a display compatible with the fiber optic ferrule inspection tools of FIGS. 1 and 23, the display illustrating a pair of images of a fiber optic ferrule that is being inspected by the fiber optic ferrule inspection tool.

### DETAILED DESCRIPTION

According to the principles of the present disclosure, a fiber optic ferrule inspection tool with contamination detection and a cleaning device is provided. The tool integrates the functions of contamination detection and cleaning within the same device. In particular, a connector or a ferrule may be inserted into a port of the tool and may be inspected and cleaned while the connector or the ferrule is held within the port without removing the connector or the ferrule from the port. The cleaning may be performed first followed by the inspection. Alternatively, the inspection may be done first followed by the cleaning. The cleaning and/or the inspection may be done a plurality of times. For example, the connector or the ferrule may be first cleaned followed by inspection and may be further cleaned after inspection. A final inspection may be performed after the last cleaning. In certain embodiments, the cleaning may be initiated by wiping an end face of the connector or the ferrule with a cloth prior to inserting the connector or the ferrule into the port of the tool. As mentioned above, certain ferrules may be made of a material (e.g., a plastic) that may become electrostatically charged upon wiping the ferrule with the cloth.

The cleaning by the tool may include ionizing air and impinging the ionized air against the end face of the ferrule and generally surrounding at least portions of the ferrule with the ionized air. The ionized air may at least partially electrostatically neutralize the ferrule and thereby facilitate the cleaning of the ferrule of dust, dirt, hair, and/or other contaminants that are attracted to the ferrule by electrostatic attraction. Furthermore, electrostatically neutralizing the ferrule and/or the connector may reduce or eliminate the tendency of the ferrule and/or the connector to later attract contaminants via electrostatic attraction.

The inspection and cleaning tool may be suitable for single fiber connectors and/or single fiber ferrules. In addition, the cleaning and inspection tool may be suitable for multi-fiber connectors and/or multi-fiber ferrules. The port of the cleaning and inspection tool may include an adapter that facilitates connecting a variety of fiber optic connectors and/or fiber optic ferrules. Example fiber optic ferrules and connectors that may be compatible with the inspection and cleaning tool via an appropriate adapter include MPO and MTP connectors, MT ferrules, PC and APC connectors and ferrules, etc. The ferrules and/or connectors may include one or more pins or may include no pins. The ferrules and/or connectors may include one or more pin holes or may include no pin holes.

In certain embodiments, the inspection and cleaning tool may include a camera for viewing the ferrule and/or the connector. In certain embodiments, the camera may be included on a microscope. In certain embodiments, the complete ferrule surface being inspected may be inspected without moving an X-Y stage. The field of view of the camera may be sufficient to view the entire surface being inspected in a single view and thereby make moving the ferrule unnecessary while being inspected and thereby eliminate the need for an X-Y stage.

A grazing light may be used to illuminate the ferrule and/or the connector. The grazing light may include the ability to emit multiple wave lengths of electromagnetic radiation (e.g., ultraviolet radiation, blue light, various frequencies of visible light, etc.). The grazing light may include laser light, may be monochromatic, may be polychromatic, etc. The grazing light may be used to highlight contamination on the end face of the ferrule and/or the connector. The grazing light may be oriented such that rays of the electromagnetic radiation emitted by the grazing light are oblique to the end face of the ferrule and/or the connector. The grazing light may thereby illuminate contaminants such as dust particles, lint, hair, etc. and thereby enable detection of the contaminants by the camera.

The inspection and cleaning tool may further include a source of electromagnetic radiation (i.e., a light) whose rays are substantially oriented parallel to light entering the camera. The electromagnetic radiation that is oriented substantially parallel to the camera axis may be polarized prior to the electromagnetic radiation illuminating the end face of the connector. Electromagnetic radiation reflected from the end face of the ferrule may be polarized by a second polarizer prior to being received by the camera. The first and second polarizers may be angularly adjustable with respect to each other. By adjusting the polarizers with respect to each other, the polarizers may be oriented parallel to each other, perpendicular to each other, or at any angle between parallel and perpendicular to each other. The polarized light may be used to highlight scratches on the end face of the ferrule and thereby detect defects in the ferrule and/or the connector.

The inspection and cleaning tool may include a module that produces a blast of ionized air over the end face of the ferrule and/or the connector and thereby cleans and electrostatically neutralizes the ferrule and/or the connector during inspection. The cleaning may remove particles of lint, dust, dirt, etc. without having to take the connector and/or the ferrule out of the inspection and cleaning tool. The module may additionally provide a persistent overpressure/flow of ionized air and thereby prevent dust from collecting inside the inspection and cleaning tool.

The adapter may be adapted to hold a specific connector or ferrule and thereby allow installation of the connector or the ferrule into the port of the inspection and cleaning tool. Alternatively, an adapter may hold several styles of connectors and/or ferrules. For example, an adapter may be inclined at a 4° angle and thereby be suited to hold PC as well as APC connectors and ferrules in the inspection and cleaning tool. Alternatively, a tilting device adapter may cover both PC and APC connectors and ferrules. Certain connectors and ferrules have end faces angled at about 8° from a longitudinal axis of the optical fibers carried therein. Other ferrules and connectors have end faces substantially perpendicular to the longitudinal axis of the optical fibers carried therein. By including an adapter that is inclined at a 4° angle, the 8° style of connectors and ferrules will be held at about 4° from the axis of the camera, and perpendicular style connectors and ferrules will also be held at about 4° to the axis of the camera by the same adapter.

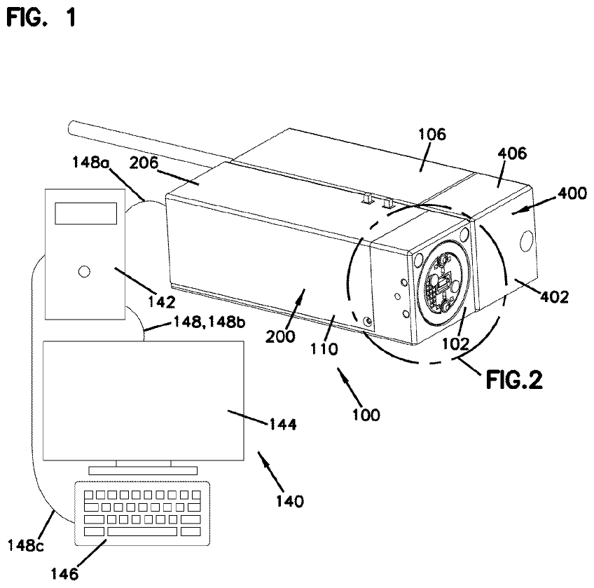

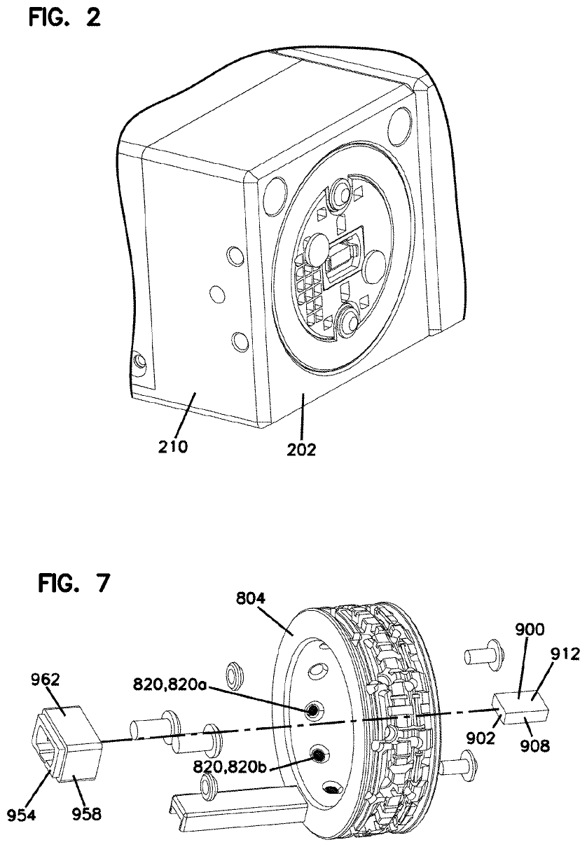

Turning now to the figures and in particular to FIGS. 1-9, an inspection tool 100 is illustrated according to the principles of the present disclosure. The inspection tool 100 may also be referred to as an inspection and cleaning tool, a cleaning tool, a fiber optic ferrule inspection tool, etc. The inspection tool 100 may be used before applying physical contact for testing insertion loss, reflection loss, etc. As mentioned above, a cloth 190 may be used to clean a first end 902 of a ferrule/connector 900 prior to the ferrule/connector 900 being inserted into a port 290 of the inspection tool 100. As depicted, the first end 902 is the inspected surface of the ferrule/connector 900. In other embodiments, other features of the ferrule/connector 900 may be additionally inspected by the inspection tool 100. As depicted, the first end 902 is the primary surface being cleaned and/or inspected by the inspection tool 100. In other embodiments, additional features of the ferrule/connector 900 may be cleaned and/or inspected by the inspection tool 100. In the depicted embodiment, the first end 902 terminates one or more optical fibers. In certain embodiments, the optical fiber or optical fibers are terminated at the first end 902 substantially perpendicular to the axis of the optical fiber. In other embodiments, the first end 902 is inclined at an angle (e.g., 8°) to the axis of the optical fiber(s).

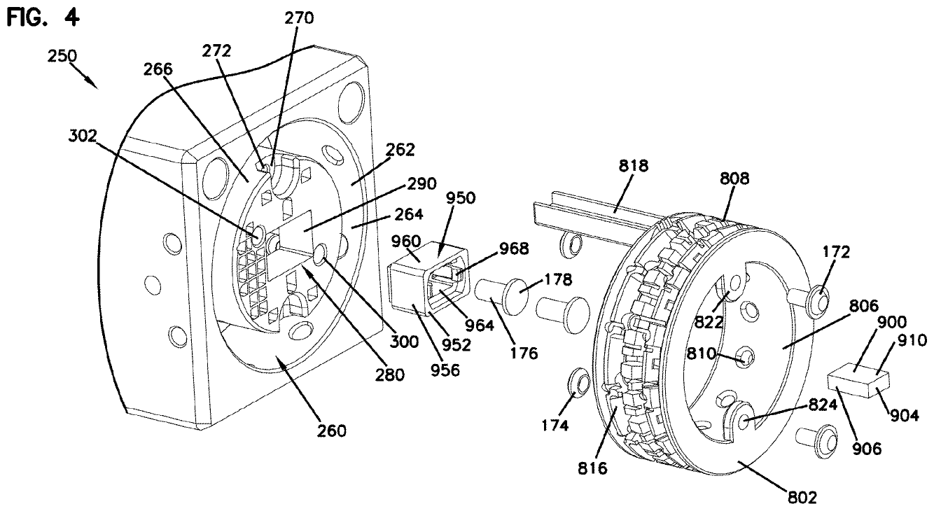

The ferrule/connector 900 is depicted as a semi-schematic ferrule/connector. The ferrule/connector 900 may be an MPO connector, an MTP connector, an MT ferrule, a PC connector, an APC connector, a PC ferrule, an APC ferrule, etc. The ferrule/connector 900 may include pins, may include pin holes, may include no pins, and/or may include no pin holes. As illustrated at FIGS. 4 and 7, the ferrule/connector 900 may extend between the first end 902 and a second end 904. The ferrule/connector 900 may further extend between a first side 906 and a second side 908. The ferrule/connector 900 may further extend between a third side 910 and a fourth side 912.

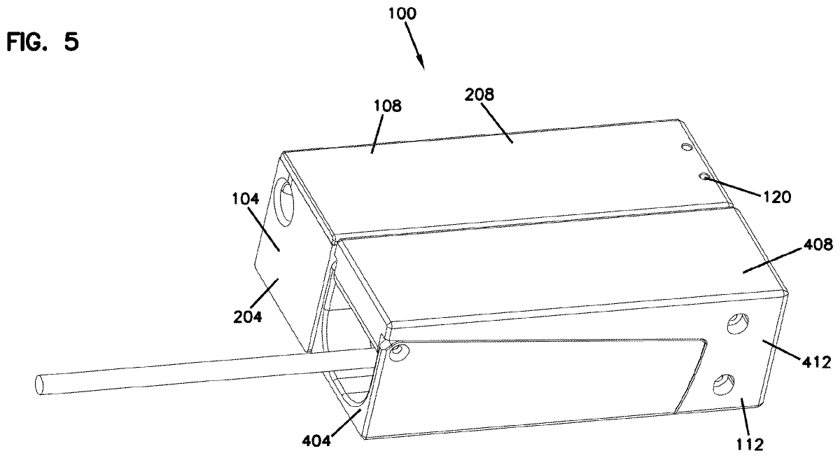

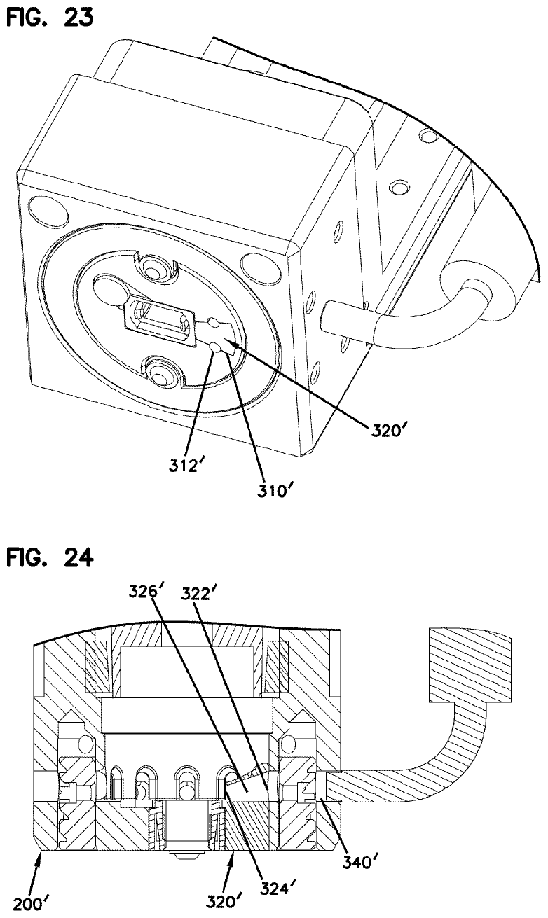

Turning to FIGS. 1 and 5, the inspection tool 100 extends between a first end 102 and a second end 104. As depicted at FIG. 4, the port 290 is positioned at the first end 102 of the inspection tool 100. The inspection tool 100 further extends between a top 106 and a bottom 108. The inspection tool 100 further extends between a first side 110 and a second side 112. In the depicted embodiment, the inspection tool 100 includes an inspection module 200 and an ionized air supply module 400. FIGS. 23 and 24 illustrate an alternate inspection module 200′. The inspection tool 100 may include one or more attachment features 120. The attachment features 120 allow the inspection tool 100 to be attached to a work bench, a cabinet, etc. and thereby allow the inspection tool 100 to be mounted.

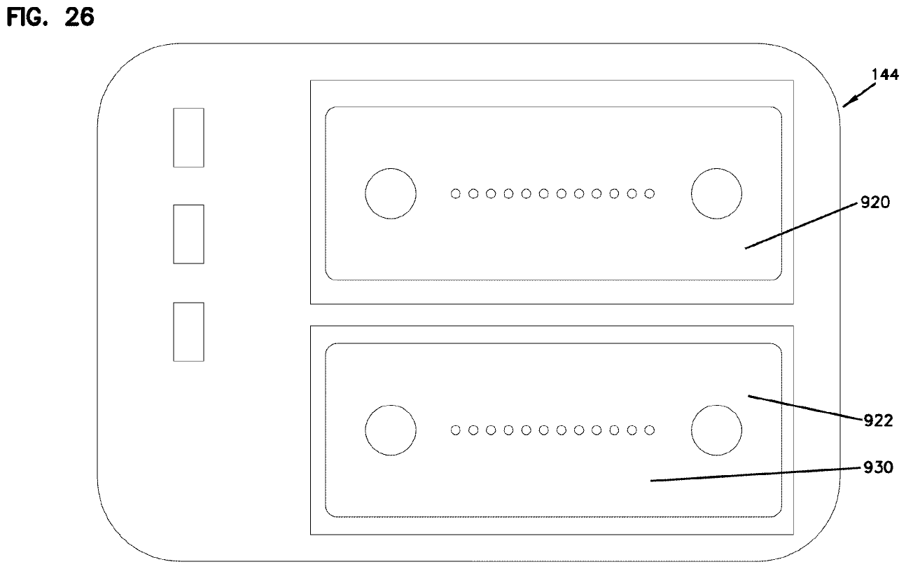

As schematically depicted at FIG. 1, the inspection tool 100 further includes a display system 140. In certain embodiments, the display system 140 may further include a control system for the inspection tool 100. As depicted, the display system 140 may include a computer 142, a display 144, an input device 146, etc. The display system 140 may further include one or more cables 148. The cables 148 may connect various components of the display system 140 to each other and/or other components of the inspection tool 100. For example, a cable 148a may attach the computer 142 to a camera 500 of the inspection tool 100. The cable 148a may be a universal serial bus (USB) cable. The cable 148a may transmit a video signal from the camera 500 to the computer 142. The cable 148a may further transmit control signals from the computer 142 to the camera 500. A cable 148b may be connected between the computer 142 and the display 144. The cable 148b may transmit a video signal from the computer 142 to the display 144 and thereby transmit one or more images 920, 922 (see FIG. 26) to the display 144. The cable 148b may transmit certain signals from the display 144 to the computer 142. For example, the display 144 may be a touch-screen display, and inputs made to the display 144 by a user (i.e., an operator) may be transmitted to the computer 142 via the cable 148b. A cable 148c is illustrated connecting the input device 146 to the computer 142. The input device 146 may include a keyboard, a mouse, a touch-screen, etc.

The inspection modules 200 and 200′ may be substantially similar to each other. In general, the features of the inspection module 200 will be described and may apply to the inspection module 200′. Features and/or components described in the context of the inspection module 200′ may generally include a call out number ending with the prime symbol (′). The inspection module 200 extends from a first end 202 to a second end 204. The inspection module 200 further extends between a top 206 and a bottom 208. The inspection module 200 further extends between a first side 210 and a second side 212. As depicted, the first end 202 of the inspection module 200 coincides with the first end 102 of the inspection tool 100. Likewise, the second end 204 of the inspection module 200 may coincide with the second end 104 of the inspection tool 100. Also, the top 206 of the inspection module 200 may coincide with the top 106 of the inspection tool 100, and the bottom 208 of the inspection module 200 may coincide with the bottom 108 of the inspection tool 100.

The ionized air supply module 400 may extend between a first end 402 and a second end 404. The ionized air supply module 400 may further extend between a top 406 and a bottom 408. The ionized air supply module 400 may also extend between a first side 410 and a second side 412.

As depicted, the ionized air supply module 400 is joined to the inspection module 200. In particular, the first side 410 of the ionized air supply module 400 is joined to the second side 212 of the inspection module 200. An air supply module attachment 350 of the inspection module 200 may be attached to an inspection module attachment 450 of the ionized air supply module 400. Suitable fasteners may be included to join the ionized air supply module 400 to the inspection module 200.

As depicted, the first end 402 of the ionized air supply module 400 may coincide with the first end 102 of the inspection tool 100. Likewise, the second end 404 of the ionized air supply module 400 may coincide with the second end 104 of the inspection tool 100. Also, the top 406 of the ionized air supply module 400 may coincide with the top 106 of the inspection tool 100, and the bottom 408 of the ionized air supply module 400 may coincide with the bottom 108 of the inspection tool 100. The second side 412 of the ionized air supply module 400 may coincide with the second side 112 of the inspection tool 100. As depicted, the attachment features 120 are illustrated at the inspection module 200. In other embodiments, the attachment features 120 may be alternatively included or may be additionally included on the ionized air supply module 400.

Additional aspects of the inspection module 200 will now be described. The inspection module 200 includes an enclosure 220 (a case, a housing, etc.). In the depicted embodiment, the enclosure 220 measures about 90 millimeters×95 millimeters×200 millimeters. As depicted, the enclosure 220 is substantially defined by a cover 230 and a base 240. The cover 230 includes an attachment 232 adapted to connect to a cover attachment 242 of the base 240.

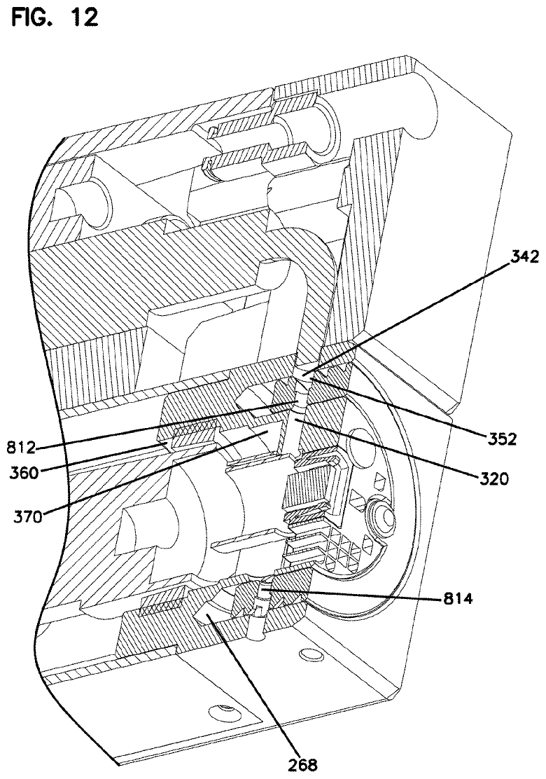

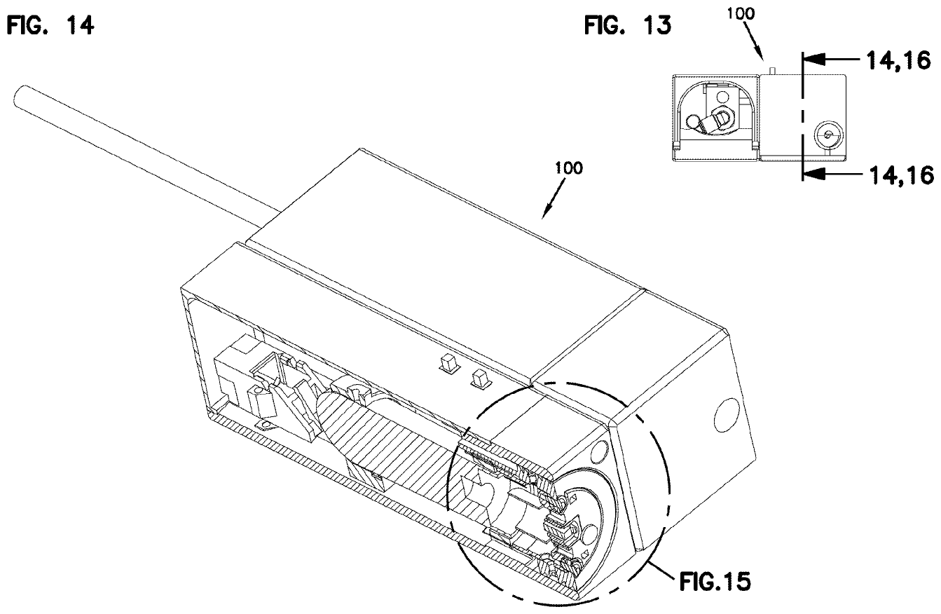

The inspection module 200 includes a mounting arrangement 216. The mounting arrangement 216 includes a variety of components and features that position the components and the features with respect to each other and with respect to the ferrule/connector 900. As depicted, the mounting arrangement 216 includes the base 240. In the depicted embodiment, the base 240 either indirectly or directly attaches to a variety of features and components within the inspection module 200. The base 240 thereby serves as a mounting member for the inspection module 200. As illustrated at FIG. 4, the base 240 includes a block structure 250 positioned at the first end 200 of the inspection module 200. The block structure 250 compactly mounts a variety of components and features of the inspection module 200. The base 240 further includes a rear camera body attachment 244, a power attachment 246, and a communications attachment 248. As illustrated, the power attachment 246 and the communications attachment 248 are positioned toward the second end 204 of the inspection module 200. As depicted, the rear camera body attachment 244 is positioned on the base 240 at a medial position between the first end 202 and the second end 204 of the inspection module 200. As illustrated at FIG. 12, a front camera body attachment 360 is included at the block structure 250 of the base 240.

As depicted at FIG. 4, the block structure 250 includes a grazing light source attachment 260. In the depicted embodiment, the grazing light source attachment 260 includes an annular recess 262 with an outer diameter 264 and an inner diameter 266. The annular recess 262 includes a bottom 268. The grazing light source attachment 260 further includes a mount 270 with a fastener hole 272. As also illustrated at FIG. 4, the block structure 250 includes an adapter attachment 280. The adapter attachment 280 includes a wall 282 (i.e., a bulkhead), a first side 284, a second side 286, and the port 290. As illustrated, the port 290 extends between a first side 292 and a second side 294. The port 290 further extends between a third side 296 (e.g., a top) and a fourth side 298 (e.g., a bottom). The adapter attachment 280 further includes a fastener hole set 300. The fastener hole set 300 includes one or more front holes 302 and/or one or more rear holes 304.

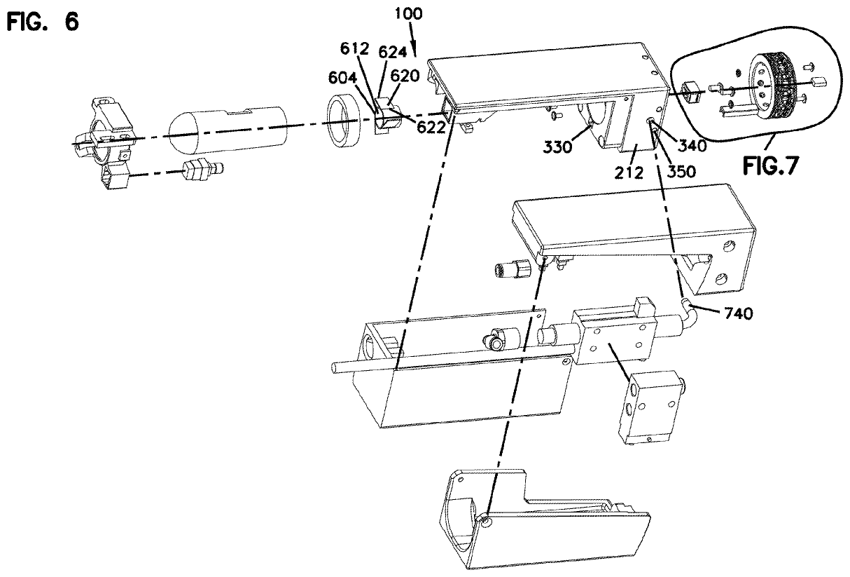

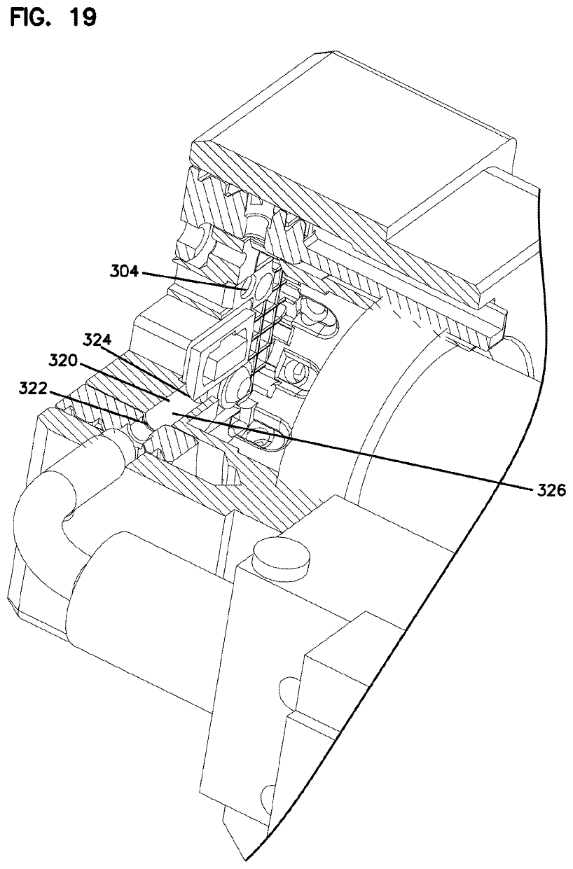

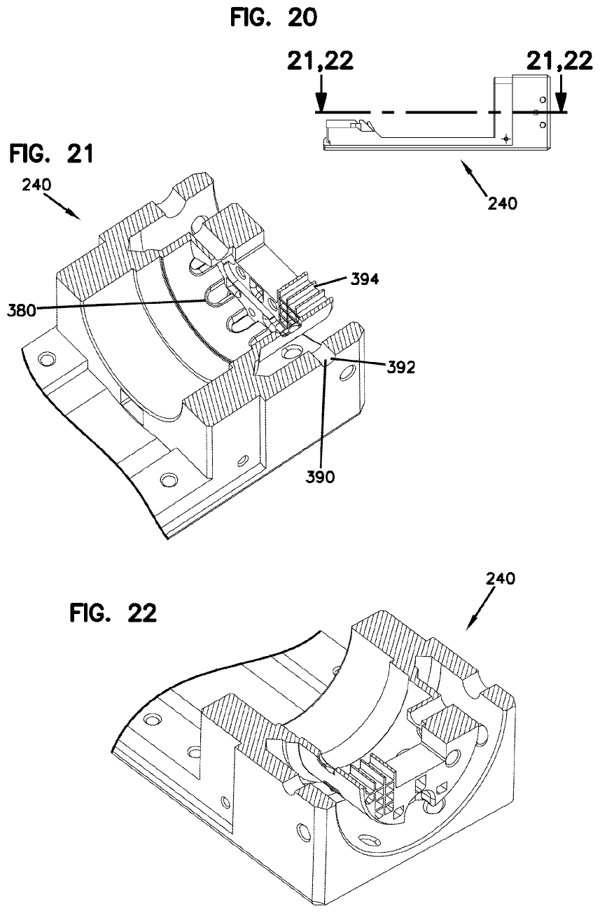

As illustrated at FIG. 19, the block structure 250 may include a nozzle 320. The nozzle 320 is integrated with the block structure 250. In another embodiment illustrated at FIGS. 23 and 24, the nozzle 320′ is a removable nozzle. Embodiments with the removable nozzle 320′ may include removable nozzle attachment features 310′ and/or fastener receivers 312′. As illustrated at FIG. 6, the block structure 250 includes one or more passages 330. The passages 330 may allow power and/or control cable passage to a grazing light apparatus 800. The block structure 250 may further include an air supply passage 340, 340′. The air supply passage 340, 340′ may include attachment features. The air supply passage 340, 340′ may include a port (e.g., a hole). The block structure 250 of the base 240 may further include an aperture mount 370, as illustrated at FIG. 12. As illustrated at FIG. 21, the block structure 250 may further include a plurality of grazing light openings 380. In addition to the air supply passage 340, the block structure 250 may include a variety of air flow exhausts 390. For example, as illustrated at FIG. 21, the block structure 250 may include a side exhaust 392 and/or a front exhaust 394. As illustrated at FIG. 12, the block structure 250 allows ionized air 352 to flow through the block structure 250 and across the first end 902 of the ferrule/connector 900. In particular, the ionized air 352 may pass through the nozzle 320, 320′ and thereby be directed to the first end 902 of the ferrule/connector 900 (see FIG. 19). The ionized air 352 may continue and exit through the air flow exhaust 390. The air flow exhaust 390 may include the side exhaust 392 and/or the front exhaust 394.

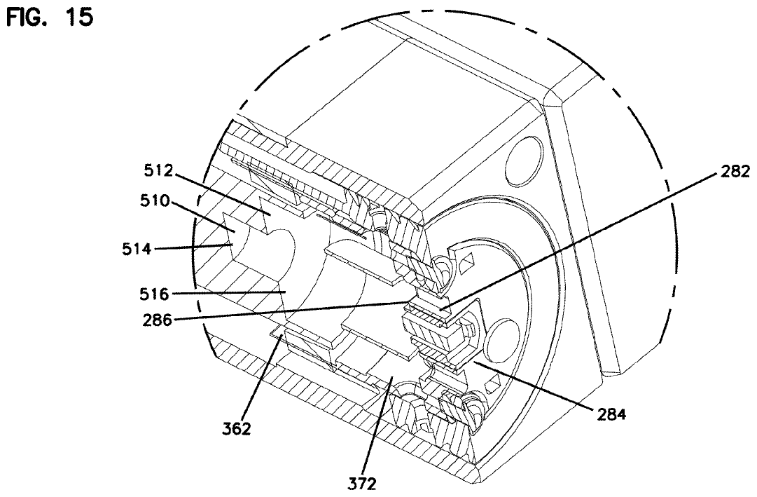

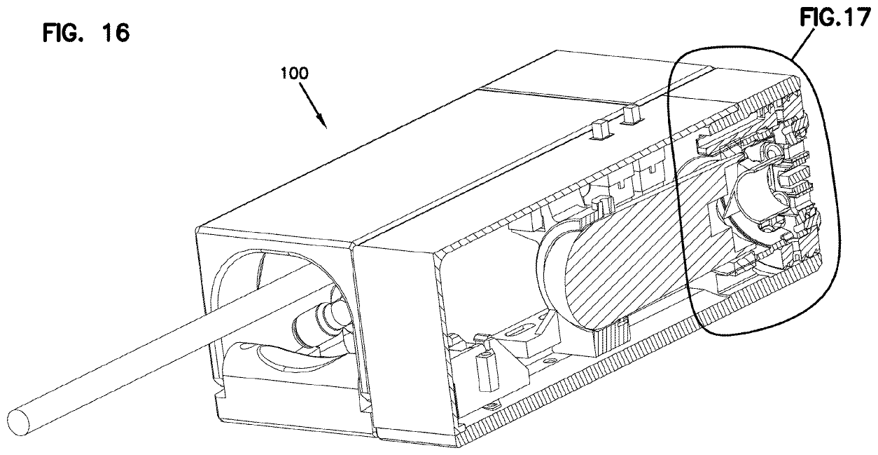

Turning again to FIG. 15, the front camera body attachment 360 and the aperture mount 370 will be described in detail. The front camera body attachment 360 includes an internal diameter 362 and a shoulder 364 adapted to interface with a front mount 520. The front mount 520 includes an interior 522 and an exterior 524. The exterior 524 may interface with the internal diameter 362 of the front camera body attachment 360. The aperture mount 370 similarly includes an internal diameter 372 and a shoulder 374. The aperture mount 370 is adapted to mount an aperture 600 to the block structure 250.

The camera 500 will now be described in detail. In certain embodiments, the camera 500 may be included on a microscope. As mentioned above, the camera may include a viewing area sufficiently large to view the entire first end 902 of the ferrule/connector 900 without moving the ferrule/connector 900 relative to the camera 500. The camera 500 may include an aperture 510 (i.e., a light receiver). The aperture 510 may include a receiving lens. As depicted, the receiving lens has a 1×magnification. A sensing chip within the camera 500 may be a half-inch sensing chip and thereby may give a 6.4×4.8 millimeter image of the first end 902 of the ferrule/connector 900 on the half-inch camera sensing chip. In other embodiments, other lenses may be used. The aperture 510 may include an objective lens. As depicted, the aperture 510 includes a polarizing filter 514. In the depicted embodiment, the polarizing filter 514 may remain stationary with respect to the aperture 510. The camera 500 may have a resolution of 5 μm/pixel, 2.5 μm/pixel, 1.7 μm/pixel, etc. The optical resolution of the camera 500 may be 5.2 μm. The depth of field of the camera 500 may be 620 μm. In certain embodiments, the camera 500 may be a 1.3 megapixel camera. In other embodiments, the camera 500 may be a 5 megapixel camera. In other embodiments, the camera 500 may have alternate resolutions, alternate depths of field, and/or alternate megapixel capacity. In certain embodiments, the camera 500 may be capable of receiving ultraviolet light. In certain embodiments, the camera 500 may have an output of 1,280×1,024 pixels at a rate of 25 frames per second. In certain embodiments, the camera 500 may have an output of 2,560×1,920 pixels at a rate of 6 frames per second. In still other embodiments, the camera 500 may have an output of 3,840×2,748 pixels at 3 frames per second. In other embodiments, the camera 500 may have other outputs at other frame rates. The camera 500 may include a USB output/input to the computer 142. The camera 500 may use auto exposure and/or light-color balance with the aid of the computer 142.

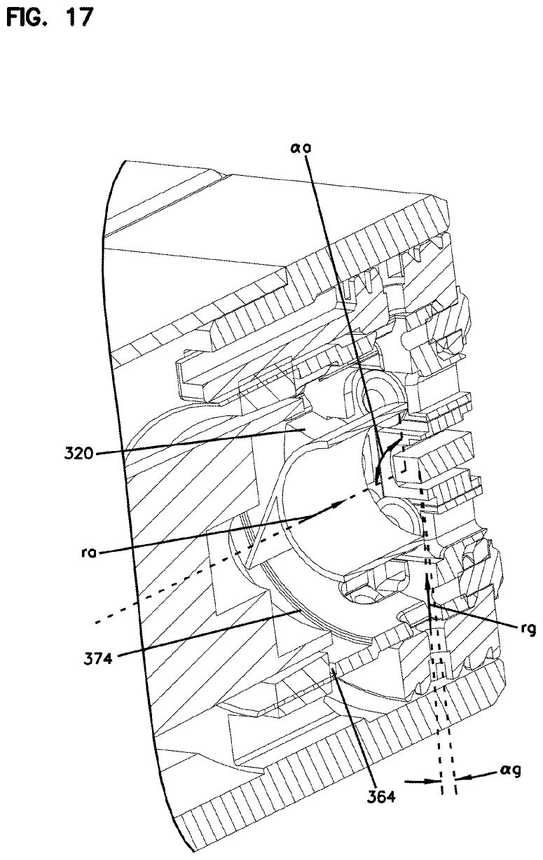

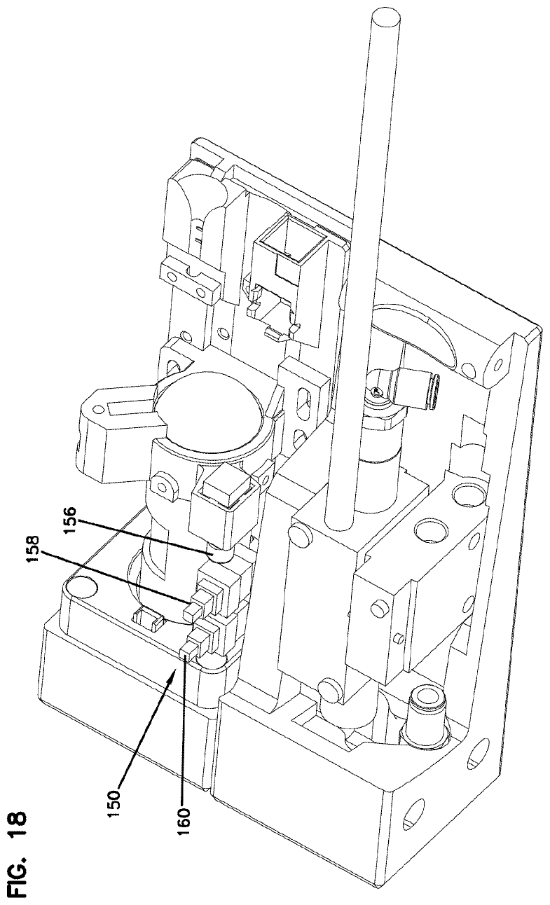

The camera 500 may extend between a first end 502 and a second end 504. As depicted, light (i.e., electromagnetic radiation) enters the camera 500 through the first end 502. As depicted, the camera 500 includes a substantially cylindrical exterior 506 or a truncated conical exterior 506. The camera 500 includes a first mounting area 508a and a second mounting area 508b. As depicted, the first mounting area 508a is adapted to be held by the interior 522 of the front mount 520. The second mounting area 508b is adapted to be held by an interior 532 of a rear mount 530. The rear mount 530 further includes an exterior 534 and is adapted to be mounted to the rear camera body attachment 244 of the base 240. As depicted, the camera 500 includes an annular light 512. As depicted, the annular light 512 surrounds or substantially surrounds the aperture 510 of the camera 500. As depicted at FIG. 17, the annular light 512 emits light rays ra of light that are close to parallel to a central longitudinal axis A1 of the camera 500. As illustrated at FIG. 17, an angle αa is defined between the first end 902 of the ferrule/connector 900. In certain embodiments, the angle αa may vary within an angular range of 30° to 90°, where 90° is perpendicular to the first end 902 of the ferrule/connector 900. In certain embodiments, the angle αa may vary within an angular range of 75° to 90°, where 90° is perpendicular to the first end 902 of the ferrule/connector 900. The annular light 512 may be covered by a second polarizing filter 516. The second polarizing filter 516 may be rotatable with respect to the first polarizing filter 514, and the polarizing filters 514, 516 may thereby be rotated with respect to each other during an inspection process using the inspection tool 100.

Turning now to FIGS. 4 and 7, the grazing light apparatus 800 will be described in detail. The grazing light apparatus 800 may be described as an illumination ring, a grazing light assembly, an oblique light, a flood light, a stray light, etc. The grazing light apparatus 800 may highlight dust particles and/or other contaminants at the first end 902 of the ferrule/connector 900. The grazing light apparatus 800 may give optimal illumination for contamination detection. However, the grazing light apparatus 800 may also illuminate scratches and/or other defects at the first end 902 of the ferrule/connector 900. The grazing light apparatus 800 extends between a first side 802 and a second side 804. The grazing light apparatus 800 includes an interior 806 and an exterior 808. The grazing light apparatus 800 may include a wire channel 818. As depicted, the wire channel 818 extends beyond the second side 804 of the grazing light apparatus 800. The grazing light apparatus 800 includes a plurality of light holders 810. In the depicted embodiment, the light holder 810 is adapted to hold light emitting diode (LED) type lighting elements 820. In other embodiments, the light holder 810 may be adapted to hold other types of light emitting elements 820. The lights 820 may include ultraviolet lights, blue lights, laser lights, etc. The lights 820 may be adapted to highlight contamination found on the first end 902 of the ferrule/connector 900.

FIG. 26 illustrates an image 922 of the first end 902 of the ferrule/connector 900. The image 922 shows a plurality of contaminants 930 on the first end 902 of the ferrule/connector 900. The contaminants 930 were illuminated by the lights 820 held by the light holder 810 of the grazing light apparatus 800. The contaminants 930 absorb light emitted by the lights 820 and redirect, reemit, or otherwise transmit light detected by the camera 500. The contaminants 930 may produce 10× more contrast from being illuminated by the grazing light apparatus 800 as compared to light emitted by the annular light 512.

As illustrated at FIG. 17, the grazing light apparatus 800 is configured in a substantially annular configuration that encircles the end 902 of the ferrule/connector 900. The grazing light apparatus 800 may include a plurality of the light holders 810 and thereby illuminate the first end 902 of the ferrule/connector 900 from a plurality of locations around a perimeter of the grazing light apparatus 800. As illustrated at FIG. 7, a plurality of the lights 820 are positioned around the perimeter of the interior 806 of the grazing light apparatus 800. The lights 820 may include a first type of light emitter 820a and a second type of light emitter 820b. The first type of light emitter 820a may emit a frequency of light distinct from the second type of light emitter 820b. The plurality of frequencies of electromagnetic radiation that may be emitted by the grazing light apparatus 800 may be used one at a time or may be used in combinations with each other.

The grazing light apparatus 800 may further include a first air passage 812 and a second air passage 814. As depicted at FIG. 12, the first air passage 812 is an inlet, and the second air passage 814 is an outlet. The air passage 812 may align with a port 342 of the block structure 250. The air passage 812 may further align with the nozzle 320, 320′. The air passage 814 of the grazing light apparatus 800 may align with the side exhaust 392 of the block structure 250 of the base 240 of the inspection module 200. As depicted, the light holders 810, the air passage 812, and the air passage 814 may be substantially similar to each other. As illustrated at FIG. 4, a wire router 816 may be included around the exterior 808 of the grazing light apparatus 800. The wire router 816 accommodates routing various wires for power and/or control to the various lights 820 of the grazing light apparatus 800. The wire router 816 extends along a perimeter of the exterior 808 of the grazing light apparatus 800. The wires may be further fed from the wire router 816 to the wire channel 818 and thereby be routed through the grazing light power and/or control cable passage 330 of the block structure 250 of the base 240. As illustrated at FIG. 4, the grazing light apparatus 800 may further include a mounting tab 822 with a fastener hole 824. As depicted, the grazing light apparatus 800 includes a pair of the mounting tabs 822, each with one of the fastener holes 824.

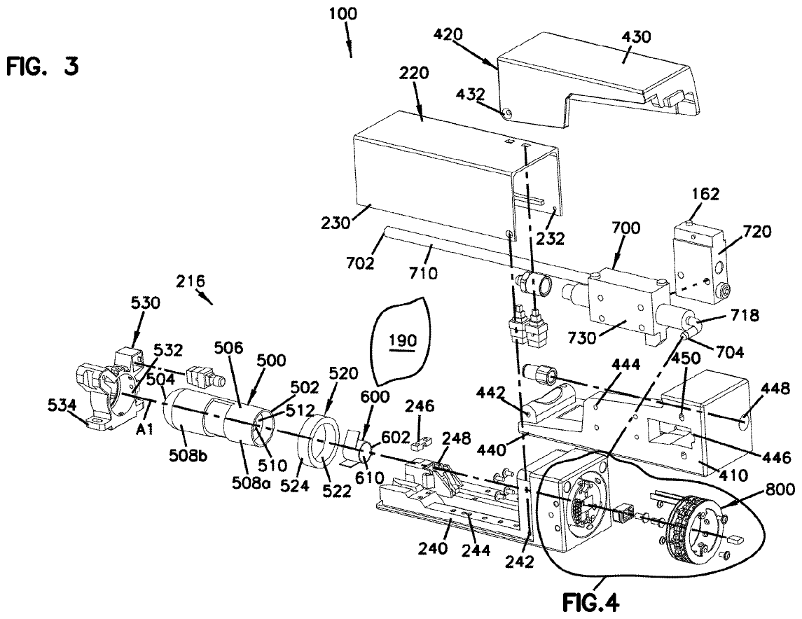

Turning now to FIGS. 3 and 6, the aperture 600 will be described in detail. The aperture 600 extends between a first end 602 and a second end 604. The aperture 600 includes a tube 610. An inside 612 of the tube 610 may be non-reflective and/or may be grooved. The aperture 600 may include a plurality of mounting fingers 620. The mounting fingers 620 may extend between a radial end 622 and an extended end 624. As illustrated at FIG. 17, the aperture 600 manages light within the inspection module 200, 200′. In particular, light emitted directly by the lights 820 may be shielded from entering the aperture 510 of the camera 500 by the tube 610 of the aperture 600. The aperture 600 thereby manages how light is received by the aperture 510 of the camera 500. The extended end 624 of the mounting fingers 620 may provide a mount for the aperture 600 within the block structure 250 of the base 240. In particular, the extended end 624 may mount to the aperture mount 370 of the block structure 250.

Turning again to FIG. 17, a ray rg of grazing light emitted by the grazing light apparatus 800 is illustrated heading toward the first end 902 of the ferrule/connector 900. As illustrated, the ray rg forms an angle αg with the first end 902 of the ferrule/connector 900. In certain embodiments, the angle αg is shallow and may range from between 15° to 30° to the first end 902 of the ferrule/connector 900. In certain embodiments, the angle αg is shallow and may range from between 0° to 30° to the first end 902 of the ferrule/connector 900. (An angle of 0° would be equivalent to being parallel with the first end 902 of the ferrule/connector 900).

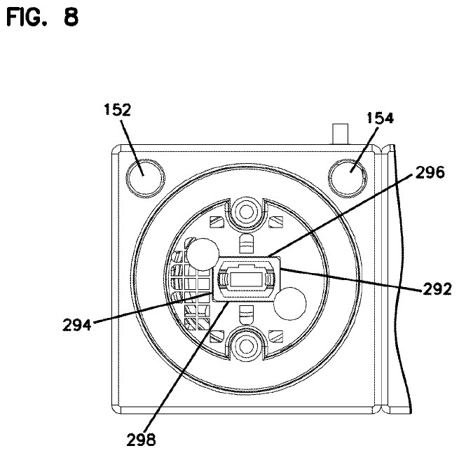

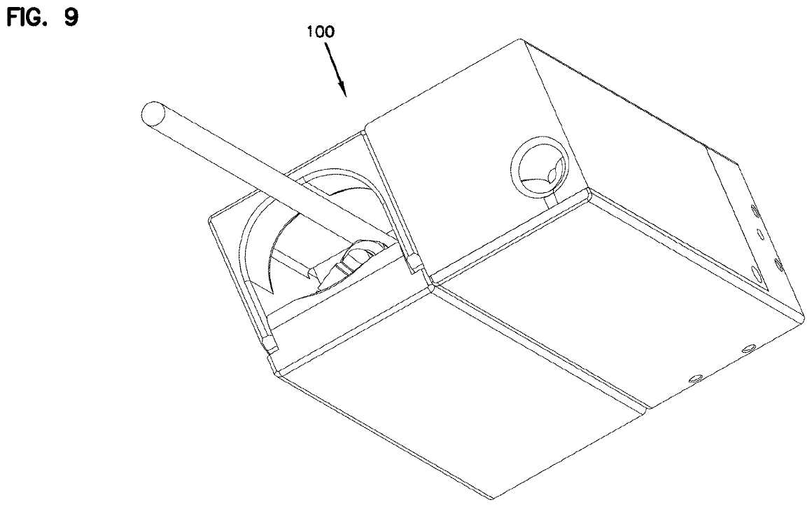

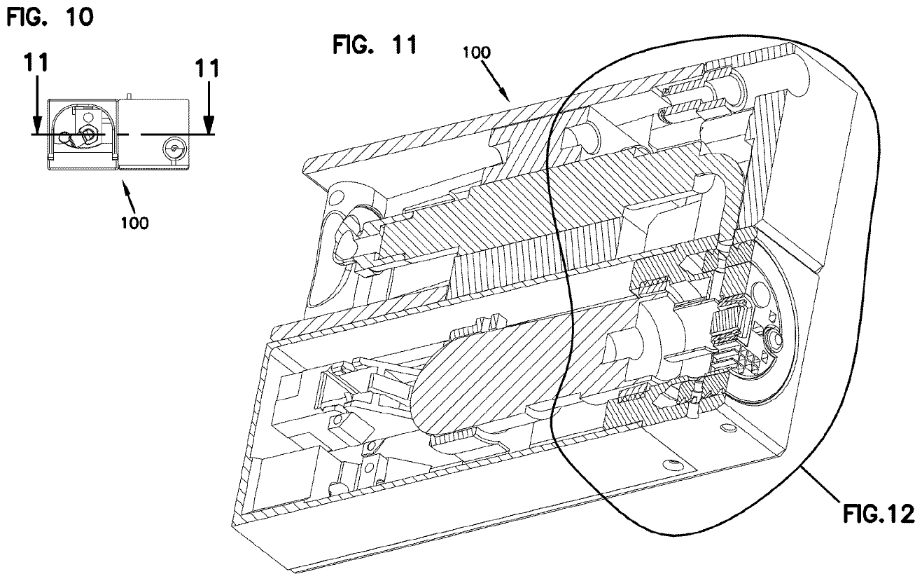

Turning again to FIGS. 4 and 7, the mounting of the ferrule/connector 900 to the inspection module 200, 200′ and, in particular, to the block structure 250 will be described in detail. The port 290 of the block structure 250 is adapted to receive an adapter 950. The adapter 950 extends between a first end 952 and a second end 954. The adapter 950 further extends between a first side 956 and a second side 958. The adapter 950 further extends between a third side 960 and a fourth side 962. The first side 956, the second side 958, the third side 960, and the fourth side 962 generally form an exterior of the adapter 950. The exterior of the adapter 950 mounts within the port 290 of the block structure 250. FIG. 8 illustrates the positioning of the first side 292, the second side 294, the third side 296, and the fourth side 298 of the port 290. The first side 956 of the adapter 950 generally corresponds in position with the second side 294 of the port 290. Likewise, the second side 958 of the adapter 950 generally corresponds in position with the first side 292 of the port 290. The third side 960 of the adapter 950 generally corresponds with the third side 296 of the port. And, the fourth side 962 of the adapter 950 generally corresponds with the fourth side 298 of the port 290.

The insertion of the adapter 950 into the port 290 generally controls the orientation, the lateral position, and the vertical position of the adapter 950 within the inspection module 200, 200′. As illustrated at FIG. 17, a plurality of fasteners 176 each with a flange 178 may be used to retain the adapter 950 within the port 290 of the block structure 250. As illustrated at FIG. 19, a plurality of the rear holes 304 are included around the port 290. The rear holes 304 are spaced from the port 290 such that the flanges 178 overhang the opening of the port 290 and thereby provide support for the second end 954 of the adapter 950. Similarly, a plurality of the front holes 302 are positioned around the port 290. The front holes 302 are positioned such that the flanges 178 overhang the port 290 and thereby provide abutment for the first end 952 of the adapter 950. To quickly and easily remove a first adapter 950 and install a second adapter, the fasteners 176, installed in the plurality of the front holes 302, may be removed and the adapter 950 may be removed from the port 290. The second adapter may be installed into the port 290 and similarly secured by the set of the fasteners 176.

The adapter 950 includes an interior 964 adapted to interface with the ferrule/connector 900. The adapter 950 may thereby mount the ferrule/connector 900 and the ferrule/connector 900 may thereby be positioned and retained within the inspection module 200, 200′. As depicted, the adapter 950 includes a pair of latches 968 within the interior 964 for latching the ferrule/connector 900 within the adapter 950 and thereby latching the ferrule/connector 900 within the inspection module 200, 200′.

Details of mounting the grazing light apparatus 800 into the block structure 250 of the base 240 will now be provided. As illustrated at FIGS. 4 and 6, the wire channel 818 of the grazing light apparatus 800 is aligned with the grazing light power and/or control cable passage 330 of the block structure 250. Power and/or control cables may be threaded through the grazing light power and/or control cable passage 330 and into the interior of the enclosure 220. Appropriate internal and/or external connections may be completed between the power and/or control cables of the grazing light apparatus 800. As illustrated at FIG. 4, the grazing light apparatus 800 may then be slid into the annular recess 262 of the block structure 250. A set of fasteners 172 may be inserted through the fastener holes 824, respectively, and further through a set of washers 174 (i.e., spacers) and further into the fastener holes 272 of the mount 270 of the block structure 250.

Mounting of the camera 500 into the inspection module 200, 200′ will now be described in detail. The interior 522 of the front mount 520 may be positioned about the mounting area 508a of the camera 500. The exterior 524 of the front mount 520 may be mounted within the internal diameter 362 of the front camera body attachment 360. The mounting area 508b of the camera 500 may be mounted within the interior 532 of the rear mount 530. The rear mount 530 may be mounted to the rear camera body attachment 244 of the base 240. Various power cables may be attached to the power attachment 246, and various communications cables may be attached to the communications attachment 248. The cover 230 of the enclosure 220 may be placed upon the base 240. The cover 230 may be secured by joining the attachments 232 to the attachments 242 of the base 240, respectively.

The inspection module 200, 200′ may be controlled in part or in full by the computer 142. Alternatively to or in combination with the computer 142, a switch set 150 may be included on the inspection module 200, 200′ to control certain functions of the inspection module 200, 200′. In particular, an axial light switch 152 may be included to turn on and off the annular light 512. A grazing light switch 154 may be provided to turn on and off the lights 820 of the grazing light apparatus 800. An alternate axial light switch 156 may be provided which functions the same as or similar to the axial light switch 152. A grazing light color option switch 158 may be provided to toggle between the lights 820a, 820b, or both 820a and 820b. A polarizing phase rotator switch 160 may be provided to rotate the polarizing filters 514 and 516 relative to each other.

The ionized air supply module 400 will now be described in detail. The ionized air supply module 400 includes an enclosure 420. As depicted, the enclosure 420 includes a cover 430 and a base 440. The cover 430 may include an attachment 432, and the base 440 may include a cover attachment 442. The cover 430 may be rotatably attached to the base 440 about an axis that extends through the attachment 432 and the cover attachment 442. The base 440 may include an air supply attachment 444 and an air supply opening 446. The base 440 may further include valve adjustment access 448. The enclosure 420 substantially encloses an ionized air supply system 700.

The ionized air supply system 700 may supply a stream of ionized air 352, as illustrated at FIG. 12. The ionized air 352 may clean, electrostatically neutralize, and/or prevent contaminants from entering the inspection module 200, 200′. In particular, the ionized air supply system 700 may operate in a purging mode and a cleaning mode. The ionized air supply system 700 may additionally be turned off.

The ferrule/connector 900 may remain in the port 290 of the inspection module 200, 200′ while the ionized air supply system 700 switches between the purge mode, the cleaning mode, and the off configuration. The inspection module 200, 200′ may perform inspections while the ionized air supply system 700 is in the purge mode, the cleaning mode, and/or the off configuration. Inspections within the inspection module 200, 200′ may lead to additional cycles of operating the ionized air supply system 700 in the cleaning mode. The purge mode of the ionized air supply system 700 may supply a persistent overpressure within the enclosure 220 that may keep dust and/or other contamination out of the enclosure 220. The purge mode may effectively perform the purging function, even if the ferrule/connector 900 is removed from the port 290 of the inspection module 200, 200′. The cleaning mode of the ionized air supply system 700 may blast ionized air 352 at the ferrule/connector 900 with a supply pressure of 6 bar.

As illustrated at FIG. 3, the ionized air supply system 700 may include an inlet 702 and an outlet 704. The ionizing elements of the ionized air supply system 700 may be close to or at the outlet 704, as the ionization of the ionized air 352 may decay upon the ionized air 352 leaving the ionizing elements of the ionized air supply system 700. The ionizing elements of the ionized air supply system 700 may be supplied by a high voltage supply 708. The high voltage supply 708 may be supplied a voltage of 10,000 Volts. A supply hose 710 may be routed to the ionized air supply system 700 and thereby provide the ionized air supply system 700 with pressurized air.

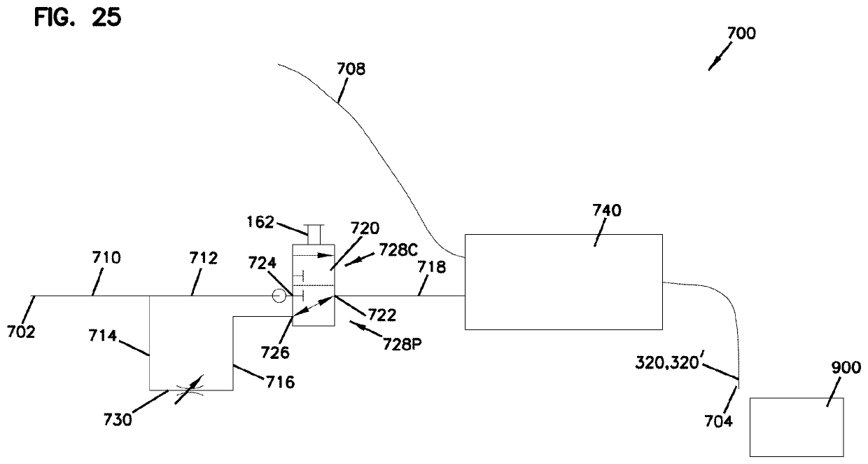

As illustrated at FIG. 25, the ionized air supply system 700 includes a main cleaning flow valve 720 and a constant purge valve 730. Pressurized air enters the inlet 702 and may be routed along a cleaning branch 712 or a purge branch 714, depending on a position of the main cleaning flow valve 720. In particular, the cleaning branch 712 extends from the inlet 702 to a second port 724 of the main cleaning flow valve 720. The purge branch 714 extends between the inlet 702 and the constant purge valve 730. A purge to cleaning valve connection 716 extends between the constant purge valve 730 and a third port 726 of the main cleaning flow valve 720.

The main cleaning flow valve 720 includes a cleaning position 728C and a purge position 728P. The cleaning position 728C corresponds to the cleaning mode of the ionized air supply system 700, and the purge position 728P corresponds with the purging mode of the ionized air supply system 700. At the purge position 728P, as illustrated at FIG. 25, the main cleaning flow valve 720 connects the third port 726 to a first port 722 and thereby provides purging air to a cleaning valve to ionizer connection 718. By pressing a valve switch 162, the main cleaning flow valve 720 switches to the cleaning position 728C. The cleaning position connects the second port 724 with the first port 722 of the main cleaning flow valve 720 and thereby connects the cleaning branch 712 to the cleaning valve to ionizer connection 718. Actuation of the valve switch 162 may be accomplished by depressing the cover 430 and thereby rotating the cover 430 about the attachment 432. Thus, by depressing a top surface of the cover 430, the cleaning position 728C of the main cleaning flow valve 720 may be selected, and the cleaning mode of the ionized air supply system 700 may be activated. Upon releasing the cover 430, the main cleaning flow valve 720 is spring returned to the purge position 728P.

The cleaning valve to ionizer connection 718 supplies air to an ionizer 740. The ionizer 740 may be positioned close to the nozzle 320, 320′ to minimize the ionization decay of the ionized air 352. The ionizer 740 may include a sharp pin coaxially centered about a tube. High voltage potential may be supplied between the sharp pin and the tube and thereby ionized air which passes between the sharp pin and the tube. No sparks are typically generated between the sharp pin and the surrounding tube.

As the ionized air 352 exits the outlet 704, the ionized air 352 directly or indirectly enters the nozzle 320, 320′. In certain embodiments, the ionizing elements of the ionized air supply system 700 may be included within the nozzle 320, 320′. The nozzle 320, 320′ includes an inlet 322, 322′ and an outlet 324, 324′. A passage 326, 326′ may extend between the inlet 322, 322′ and the outlet 324, 324′. The passage 326, 326′ may be contoured and thereby direct the ionized air 352 at the first end 902 of the ferrule/connector 900 in a desired manner. In certain embodiments, the passage 326, 326′ may be angled at the outlet 324, 324′ at an angle that ranges between 15° and 30° with respect to the first end 902 of the ferrule/connector 900.

In certain embodiments, the inspection tool 100 may implement a software management system. The software management system may give the operator a better understanding of possible defects and/or contaminants (e.g., dust). The software management system may show results of different illumination pictures (e.g., by automatically switching light sources, light frequency, and/or filters (e.g., from and/or between axial illumination, various polarized filtering of illumination, grazing light, etc.). The software management system may select any of the illumination methods and any combination of the illumination methods described herein. The software management system may show, in one single image, the result of different illumination methods (i.e., overlay effect). The software management system may also show, on a single screenshot on the display 144, two, three, or more pictures of the same specimen, automatically switching the illumination methods. The software management system may be executed on the computer 142 and/or on other logical components of the inspection tool 100 (e.g., on one or more electronic circuits included on the camera 500, the display 144, etc.).

Various modifications and alterations of this disclosure will become apparent to those skilled in the art without departing from the scope and spirit of this disclosure, and it should be understood that the scope of this disclosure is not to be unduly limited to the illustrative embodiments set forth herein.

### PARTS LIST

αa angle
αg angle
ra light rays
rg grazing light ray
A1 central longitudinal axis
100 inspection tool
102 first end
104 second end
106 top
108 bottom
110 first side
112 second side
120 attachment features
140 display system/control system
142 computer
144 display
146 input device
148 cables
148a cable
148b cable
148c cable
150 switch set
152 axial light switch
154 grazing light switch
156 alternate axial light switch
158 grazing light color option switch
160 polarizing phase rotator switch
162 valve switch
172 fastener
174 washer
176 fastener
178 flange
190 cloth
200 inspection module
200′ inspection module
202 first end
204 second end
206 top
208 bottom
210 first side
212 second side
216 mounting arrangement
220 enclosure
230 cover
232 attachment
240 base
242 cover attachment
244 rear camera body attachment
246 power attachment
248 communications attachment
250 block structure
260 grazing light source attachment
262 annular recess
264 outer diameter
266 inner diameter
268 bottom
270 mount
272 fastener hole
280 adapter attachment
282 wall
284 first side
286 second side
290 port
292 first side
294 second side
296 third side
298 fourth side
300 fastener hole set
302 front holes
304 rear holes
310′ removable nozzle attachment feature
312′ fastener receivers
320 nozzle
320′ nozzle
322 inlet
322′ inlet
324 outlet
324′ outlet
326 passage
326′ passage
330 passage
340 air supply passage
340′ air supply passage
342 port
350 air supply module attachment
352 ionized air
360 front camera body attachment
362 internal diameter
364 shoulder
370 aperture mount
372 internal diameter
374 shoulder
380 grazing light opening
390 air flow exhaust
392 side exhaust
394 front exhaust
400 ionized air supply module
402 first end
404 second end
406 top
408 bottom
410 first side
412 second side
420 enclosure
430 cover
432 attachment
440 base
442 cover attachment
444 air supply attachment
446 air supply opening
448 valve adjustment access
450 inspection module attachment
500 camera
502 first end
504 second end
506 exterior
508a first mounting area
508b second mounting area
510 aperture
512 annular light
514 first polarizing filter
516 second polarizing filter
520 front mount
522 interior
524 exterior
530 rear mount
532 interior
534 exterior
600 aperture
602 first end
604 second end
610 tube
612 inside
620 mounting finger
622 radial end
624 extended end
700 ionized air supply system
702 inlet
704 outlet
708 high voltage supply
710 supply hose
712 cleaning branch
714 purge branch
716 purge to cleaning valve connection
718 cleaning valve to ionizer connection
720 main cleaning flow valve
722 first port
724 second port
726 third port
728C cleaning position
728P purge position
730 constant purge valve
740 ionizer
800 grazing light apparatus
802 first side
804 second side
806 interior
808 exterior
810 light holder
812 first air passage
814 second air passage
816 wire router
818 wire channel
820 lighting element
820a first type of light emitter
820b second type of light emitter
822 mounting tab
824 fastener hole
900 ferrule/connector
902 first end
904 second end
906 first side
908 second side
910 third side
912 fourth side
920 image
922 image
930 contaminant
950 adapter
952 first end
954 second end
956 first side
958 second side
960 third side
962 fourth side
964 interior
968 latches

1. A fiber optic ferrule inspection tool for inspecting a fiber optic ferrule, the fiber optic ferrule inspection tool comprising:
a mounting arrangement adapted to releasably mount the fiber optic ferrule;
a camera mounted to the mounting arrangement, the camera adapted to capture at least one image of the fiber optic ferrule when the fiber optic ferrule is mounted to the mounting arrangement;
a nozzle positioned by the mounting arrangement, the nozzle adapted to supply a cleaning fluid to the fiber optic ferrule and thereby clean the fiber optic ferrule with the cleaning fluid;
a grazing light assembly mounted to the mounting arrangement, wherein the grazing light assembly is adapted to emit grazing light and thereby illuminate an end of the fiber optic ferrule when the fiber optic ferrule is mounted to the mounting arrangement, and wherein the grazing light assembly is oriented such that rays (rg) of the grazing light are oriented to the end of the fiber optic ferrule within an angular range of 0 degrees to 30 degrees; and
an axial light, wherein the axial light is oriented such that rays (ra) of the axial light are oriented to the end of the fiber optic ferrule about an angular range of 30 degrees to 90 degrees when the fiber optic ferrule is mounted to the mounting arrangement.

2. The fiber optic ferrule inspection tool of claim 1, wherein the mounting arrangement is adapted to releasably mount a fiber optic connector and thereby is adapted to releasably mount the fiber optic ferrule.

3. The fiber optic ferrule inspection tool of claim 1, wherein at least a portion of the nozzle is mounted to the mounting arrangement.

4. The fiber optic ferrule inspection tool of claim 1, wherein at least a portion of the nozzle is integrated with a mounting member of the mounting arrangement.

5. The fiber optic ferrule inspection tool of claim 1, further comprising an ionizer mounted to the mounting arrangement, wherein the ionizer is adapted to ionize air, and wherein the cleaning fluid that the nozzle is adapted to supply is ionized air that is ionized by the ionizer.

6. The fiber optic ferrule inspection tool of claim 1, further comprising a valve with a first position and a second position, wherein when the valve is at the first position, the valve is adapted to deliver a flow of the cleaning fluid that is sufficient to prevent contaminants from collecting within the fiber optic ferrule inspection tool, and wherein when the valve is at the second position, the valve is adapted to deliver an increased flow of the cleaning fluid that is sufficient to remove contaminants from the fiber optic ferrule when the fiber optic ferrule is mounted to the mounting arrangement.

7. (canceled)

8. The fiber optic ferrule inspection tool of claim 1, wherein the grazing light assembly includes at least one first light emitter adapted to emit a first frequency of electromagnetic radiation and further includes at least one second light emitter adapted to emit a second frequency of electromagnetic radiation.

9. The fiber optic ferrule inspection tool of claim 1, wherein the grazing light assembly is configured in a substantially annular configuration that encircles the end of the fiber optic ferrule when the fiber optic ferrule is mounted to the mounting arrangement.

10. The fiber optic ferrule inspection tool of claim 1, wherein the grazing light assembly includes at least one fluid passage that is adapted to carry the cleaning fluid.

11. (canceled)

12. The fiber optic ferrule inspection tool of claim 1, wherein the axial light is configured in a substantially annular configuration positioned around a light receiver of the camera.

13. The fiber optic ferrule inspection tool of claim 12, further comprising a first polarizing filter positioned over the light receiver of the camera and a second polarizing filter positioned over the axial light, wherein the first and the second polarizing filters are angularly adjustable with respect to each other.

14. The fiber optic ferrule inspection tool of claim 1, further comprising an aperture positioned between the camera and the fiber optic ferrule when the fiber optic ferrule is mounted to the mounting arrangement.

15. The fiber optic ferrule inspection tool of claim 1, further comprising a plurality of adapters adapted to hold a plurality of fiber optic ferrule styles and/or a plurality of fiber optic connector styles and thereby adapted to releasably mount the fiber optic ferrule.

16. A method of inspecting a fiber optic ferrule, the method comprising:
providing a fiber optic ferrule inspection tool;
mounting the fiber optic ferrule in a port of the fiber optic ferrule inspection tool;
ionizing air with an ionizer and thereby producing ionized air;
directing a flow of the ionized air at the fiber optic ferrule within the fiber optic ferrule inspection tool thereby electrostatically neutralizing the fiber optic ferrule;
optically inspecting the fiber optic ferrule with the fiber optic ferrule inspection tool;
illuminating the fiber optic ferrule with an axial light while optically inspecting the fiber optic ferrule, wherein the axial light is oriented such that rays (ra) of the axial light are oriented to an end of the fiber optic ferrule about an angular range of 30 degrees to 90 degrees; and
illuminating the fiber optic ferrule with a grazing light while optically inspecting the fiber optic ferrule, wherein the grazing light is oriented such that rays (rg) of the grazing light are oriented to the end of the fiber optic ferrule about an angular range within 0 degrees to 30 degrees.

17. The method of claim 16, further comprising:
wiping the fiber optic ferrule with a cloth prior to mounting the fiber optic ferrule in the port of the fiber optic ferrule inspection tool; and
removing any lint of the cloth that is attached to the fiber optic ferrule with the flow of the ionized air at the fiber optic ferrule.

18. (canceled)

19. A method of inspecting a fiber optic ferrule, the method comprising:
providing a fiber optic ferrule inspection tool with a computer and/or one or more electronic circuits;
mounting the fiber optic ferrule in a port of the fiber optic ferrule inspection tool;
optically inspecting the fiber optic ferrule with the fiber optic ferrule inspection tool;
illuminating the fiber optic ferrule with an axial light while optically inspecting the fiber optic ferrule, wherein the axial light is oriented such that rays (ra) of the axial light are oriented to an end of the fiber optic ferrule about an angular range of 30 degrees to 90 degrees;
illuminating the fiber optic ferrule with a grazing light while optically inspecting the fiber optic ferrule, wherein the grazing light is oriented such that rays (rg) of the grazing light are oriented to the end of the fiber optic ferrule about an angular range within 0 degrees to 30 degrees; and
executing a software management system on the computer and/or the one or more electronic circuits and thereby automatically switching between illuminating with the axial light and the grazing light.

20. A fiber optic ferrule inspection tool for inspecting a fiber optic ferrule, the fiber optic ferrule inspection tool comprising:
a mounting arrangement adapted to releasably mount the fiber optic ferrule;
a camera mounted to the mounting arrangement, the camera adapted to capture at least one image of the fiber optic ferrule when the fiber optic ferrule is mounted to the mounting arrangement;
a grazing light assembly mounted to the mounting arrangement, wherein the grazing light assembly is adapted to emit grazing light and thereby illuminate an end of the fiber optic ferrule when the fiber optic ferrule is mounted to the mounting arrangement, and wherein the grazing light assembly is oriented such that rays (rg) of the grazing light are oriented to the end of the fiber optic ferrule within an angular range of 0 degrees to 30 degrees; and
an axial light oriented such that rays (ra) of the axial light are oriented to the end of the fiber optic ferrule about an angular range within 30 degrees to 90 degrees when the fiber optic ferrule is mounted to the mounting arrangement.

21. The fiber optic ferrule inspection tool of claim 20, further comprising a nozzle positioned by the mounting arrangement, the nozzle adapted to supply ionized air to the fiber optic ferrule and thereby clean the fiber optic ferrule.
